(19) United States
(12) Patent Application Publication
(10) Pub. No.: US 2023/0330971 A1
(43) Pub. Date: Oct. 19, 2023

(54) MULTILAYER RESILIENT FLOORING ARTICLE

(71) Applicant: Eastman Chemical Company, Kingsport, TN (US)

(72) Inventors: Robert Erik Young, Kingsport, TN (US); Michael Eugene Donelson, Kingsport, TN (US)

(73) Assignee: Eastman Chemical Company, Kingsport, TN (US)

(21) Appl. No.: 18/000,726

(22) PCT Filed: Jun. 3, 2021
(86) PCT No.: PCT/US2021/035599

§ 371 Date: Dec. 5, 2022

Related U.S. Application Data
(60) Provisional application No. 63/035,887, filed on Jun. 8, 2020.

(51) Int. Cl. B32B 23/20; C08K 5/523; C08K 3/22; C08K 3/26; C08K 5/11; C08K 5/53; B32B 23/16; B32B 23/04; B32B 23/18; E04F 15/10

(52) U.S. Cl. CPC B32B 23/20; C08K 5/523; C08K 3/22; C08K 3/26; C08K 5/11; C08K 5/53; B32B 23/16; B32B 23/04; B32B 23/18; E04F 15/105; E04F 15/107; C08K 2201/019; C08K 2003/2227; C08K 2003/265; B32B 2307/3065; B32B 2250/02; B32B 2471/00; B32B 2307/558; B32B 2307/546

(57) ABSTRACT

Disclosed is a multilayer resilient flooring article, The multilayer resilient flooring article of the present invention includes a core layer comprising a first plasticized cellulose ester-based composition and a top layer comprising a second plasticized cellulose ester-based composition, wherein the first plasticized cellulose ester-based composition comprises a combustion suppression system. Compositions useful for example in the manufacture of multilayer resilient flooring articles are also described.

### FIELD OF THE INVENTION

The present invention generally relates to multilayer resilient flooring articles and plasticized cellulose ester-based compositions useful in the manufacture thereof.

### BACKGROUND OF THE INVENTION

As the chemical industry and consumers look for environmentally friendly alternatives to certain chemicals, the growth of cellulose esters has increased significantly. Cellulose esters are plant-based compounds derived from cellulose, a polysaccharide found in wood, plants and plant products such as cotton. Cellulose esters have been used in a wide variety of consumer and industry end-product uses such as coatings and coating ingredients, objects such as eyeglass frames, disposable knives, forks, spoons, plates, cups and straws, toothbrush handles automotive trim, camera parts and disposable syringes. Cellulose esters also have intermediate and B2B product uses, often in the form of fibers, films, sheets and the like. Published studies indicate that the cellulose esters market is projected to grow from USD 9.27 billion in 2018 to USD 12.43 billion by 2023, at a CAGR of 6% from 2018 to 2023.

Despite this growth, it acknowledged in the art that challenges exist in utilizing cellulose esters in certain applications. For example, it is noted in U.S. Published Patent Application No. 2016/0068656 that, while cellulose esters are generally considered environmentally-friendly polymers and are derived from renewable sources like wood pulp, they have not been widely used in plastic compositions due to processing difficulties. The '656 application continues by referencing the absence of cellulose esters in injection molded articles and assert that this absence is due, at least in part, to the narrow temperature window between the melting point and the decomposition temperature of cellulose esters. The fact that production of film and sheet with cellulose esters has historically been limited to standard extrusion and solvent casting methods is also discussed in WO2018017652A1, assigned to the assignee of the present invention.

As evidenced by the description of above-referenced WO2018017652A1 as well as WO2018/089591A1, also assigned to the assignee of the present invention, Applicant is actively pursuing innovations which facilitate use of environmentally-friendly cellulose esters in various end-use applications. One end-use application of particular interest is so-called “resilient” flooring products that historically include vinyl sheet flooring, vinyl composite tile, luxury vinyl tile, rubber and linoleum. In this market, polyvinylchloride is a popular material but recently has encountered lower popularity due to environmental concerns. Accordingly, consumers and therefore product manufacturers are seeking alternative materials of construction.

Flooring products are typically subject to a number of standards, often created by industry organizations, that set minimum specifications or criteria for certain product performance attributes. Similarly, governmental authorities may set building codes or regulations that establish requirements for flooring products, their performance and their installation. Many of such codes and standards relate to consumer protection and product health and safety—and in that space two important sets of performance criteria are flammability and smoke generation.

In addition, resilient flooring articles must also satisfy other attributes that are critical for commercial success or may also be required to meet governmental standards for use. For example, flooring articles must often meet certain standards of wear, flexibility, impact, appearance and the like. With regard to multilayer resilient flooring articles in particular, the top or wear layer must remain substantially transparent while minimizing the transmission of ultraviolet energy to other layers, in particular an underlying layer which may carry a printed design or image (often called a print layer), which could be damaged by UV. Further, materials used in forming multilayer flooring articles and their components should be processable using flooring manufacturer's existing equipment and systems.

Despite advances in the technology, a continuing unmet need remains for flooring articles that employ environmentally-friendly materials while exhibiting flammability, smoke suppression, processability and other performance characteristics comparable to if not exceeding that of polyvinyl chloride flooring.

### SUMMARY OF THE INVENTION

In a first aspect, the present invention relates to a multilayer resilient flooring article that includes a core layer including a first plasticized cellulose ester-based composition including cellulose ester and plasticizer and a top layer including a second plasticized cellulose ester-based composition including cellulose ester and plasticizer; wherein the first plasticized cellulose ester-based composition further includes a mineral-based water releasing agent.

In another aspect, the present invention relates to a multilayer resilient flooring article that includes a core layer including a first plasticized cellulose ester-based composition including cellulose ester and plasticizer and a top layer including a second plasticized cellulose ester-based composition including cellulose ester and plasticizer; wherein the first plasticized cellulose ester-based composition further includes a phosphorus flame retardant.

In yet another aspect, the present invention relates to a multilayer resilient flooring article that includes a core layer including a first plasticized cellulose ester-based composition including cellulose ester and plasticizer and a top layer including a second plasticized cellulose ester-based composition including cellulose ester and plasticizer; wherein said multilayer flooring article exhibits a corrected smoke density (non-flaming mode) of 450 or less when tested according to ASTM E-662.

Further aspects of the invention are as disclosed and claimed herein.

### BRIEF DESCRIPTION OF THE DRAWINGS

FIG. 1 is a side elevational view of an embodiment of a multilayer resilient flooring article of the present invention.

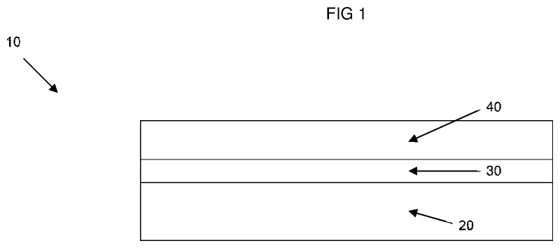

### DETAILED DESCRIPTION

For avoidance of doubt, it is expressly provided for that the information and descriptions herein regarding features or elements of one aspect of the present invention are asserted as applicable to and are relied on to also support those features and elements when described with regard to other aspects of the invention.

In a first aspect, the present invention is directed to a multilayer resilient flooring article. The term “resilient”, as used herein with respect to flooring articles, is meant to describe flooring articles that are capable of substantially returning to their original shape or position after having been flexed or compressed. Flooring articles contemplated as within the scope of present invention include without limitation any resilient or flexible material intended for use as, installation on or application to a walking surface or lower surface of a room or building. Non-limiting examples of such flooring articles include rolled flooring, squares, tiles, planks, sheet, laminate and the like which may be installed for example as a so-called “floating” floor or a glued-down floor assembly. The multilayer resilient flooring article includes a core layer of a first plasticized cellulose ester-based composition and a top layer of a second plasticized cellulose ester-based composition. The first plasticized cellulose ester-based composition includes cellulose ester and plasticizer. The second plasticized cellulose ester-based composition includes cellulose ester and plasticizer.

In a non-limiting exemplary embodiment of a multilayer resilient flooring article depicted in FIG. 3, the multilayer resilient flooring article 10 of the present invention includes a core layer 20 and a top layer 40. The multilayer resilient flooring article may also include an optional print layer 30 between the core layer 20 and the top layer 40. As discussed in more detail below, core layer 20, top layer 40 and print layer 30 may each be a calendered sheet or a calendered film. Other optional layers, such as removable backing layers, adhesive layers and the like, may also be included. Multilayer resilient flooring articles on the type contemplated herein are generally known in the art and are described for example in U.S. Pat. No. 8,071,193, the contents and disclosure of which are incorporated herein by reference.

The core layer 20, which may also be referred to as a base layer, may provide dimensional stability for the multilayer flooring article and typically has a thickness of a thickness of at least 75 mils. The core layer includes of is formed from a first plasticized cellulose ester-based composition which is further described below. The top layer 40, which may also be referred to as a wear layer, may provide scratch and abrasion resistance features for the multilayer flooring article 10 while also where applicable allowing for visibility through the top layer 40 of any underlying design or pattern on an optional print layer 30. The top layer 40 typically has a thickness of between 15 mils and 25 mils. The top layer 40 includes or is formed from a second plasticized cellulose ester-based composition, which is further described below. The optional print layer 30 may provide a visual color and/or design, for example in the form of single or multiple color shades, printed geometric patterns or images, and typically has a thickness of between 1 mil and 20 mils.

An important feature of the present invention is that the first plasticized cellulose ester-based composition and the second plasticized cellulose ester-based composition comprises one or both of a mineral-based water releasing agent and a phosphorus flame retardant. The mineral-based water releasing agent and the phosphorus flame retardant may be referred to herein alone or in combination from time to time as a “combustion suppression system”. In one or more embodiments, the first plasticized cellulose ester-containing composition includes a mineral-based water releasing agent. In one or more embodiments, the first plasticized cellulose ester-containing composition includes phosphorus flame retardant. In one or more embodiments, the first plasticized cellulose ester-containing composition includes mineral-based water releasing agent and phosphorus flame retardant.

The phrase “combustion suppression system” as used herein is intended to mean an ingredient or combination of ingredients which may impart(s) flame and/or smoke suppression to a composition that includes it (as measured for example as corrected non-flaming smoke density as tested according to ASTM E-662). In one or more embodiments, at least one of the first plasticized cellulose ester-based composition and the second plasticized cellulose ester-based composition comprises from 1% to 75% by weight or from 1% to 40% by weight of a combustion suppression system based on the total weight of the plasticized cellulose ester-based composition.

The mineral-based water releasing agent of the present invention is any inorganic mineral-based compound which releases water molecules in some form upon exposure to elevated temperatures. In one or more embodiments, the combustion suppression system includes from 1 to 100% by weight mineral-based water releasing agent based on the total weight of the combustion suppression system. In one or more embodiments, the mineral-based water-releasing agent is present in the first plasticized cellulose ester-based composition in an amount of from 5% to 60% by weight or from 20% to 60% by weight based on the total weight of the first plasticized cellulose ester-based composition. In one or more embodiments, the second plasticized cellulose ester-containing composition is substantially free of a mineral-based waster releasing agent.

One non-limiting example of the mineral-based water releasing agent of the present invention is alumina trihydrate (also referred to herein as “ATH”) which includes three water molecules that are released at approximately 220° C. in an endothermic reaction. Another non-limiting example of the mineral-based water releasing agent of the present invention is magnesium hydroxide (also referred to herein as “MDH”) which dehydrates in a manner similar to ATH but at about 330° C. Other mineral-based water releasing agents are known in the art and include aluminum hydroxide, magnesium hydroxide, hydrated magnesium carbonate (also referred to as hydromagnesite), huntite, calcium sulfate, calcium hydroxide, boron trihydrate, zinc borate, zinc hydroxide, sodium borate, sodium tetraborate pentahydrate, sodium tetraborate decahydrate, sodium tetraborate octahydrate. In one or more embodiments, the combustion suppression system may include mixtures of two or more mineral-based water-releasing agents.

Alumina trihydrate and methods for it manufacture are known in the art and are described for example in U.S. Pat. No. 7,704,471, the contents and disclosure of which are incorporated herein by reference. Alumina trihydrate may be particulate alumina trihydrate and may have an average particle size of from 1.5 microns to 100 microns. Particulate alumina trihydrate may be formed vis precipitation or may be ground into particles of suitable size via known grinding techniques. Particulate alumina trihydrate may be coated particulate alumina trihydrate and include a coating of for example vinyl silane, amino silane, fatty acids, epoxy silanes, phenyl silanes and the like. In one or more embodiments, the combustion suppression system includes from 1 to 100% by weight alumina trihydrate based on the total weight of the combustion suppression system. A suitable alumina trihydrate is commercially available from Huber under the trade name Micral™ 932.

MDH and methods for its manufacture are known in the art and are described for example in U.S. Pat. Nos. 4,145,404 and 4,098,762, the contents and disclosure of which are incorporated herein by reference. In one or more embodiments, the combustion suppression system includes from 1 to 100% by weight magnesium hydroxide based on the total weight of the combustion suppression system. In one or more embodiments, the first plasticized cellulose ester-based composition includes from 1% to 60% by weight magnesium hydroxide based on the total weight of the first plasticized cellulose ester-based composition.

In one or more embodiments, the first plasticized cellulose ester-based composition includes a phosphorus flame retardant. The phrase “phosphorus flame retardant” as used herein is intended to include phosphorus compounds having a total phosphorus content of between 2 weight % and 70 weight % based on the total weight of the compound and a phosphorus oxidation state of between 0 and +5. Non-limiting examples of phosphorus flame retardants include red phosphorus, Resorcinol Diphenyl Phosphate (RDP), DOPO (6H-dibenz(C,E)(1,2)oxaphosphorin-6-oxide), resorcinol bis (2,6 xylyl phosphate) (RXP), triphenyl phosphate (TPP), tricresyl phosphate (TCP or TKP) triaryl phosphate (TAP), bisphenol A diphosphate (BAPP, BDP) and combinations thereof. Suitable phosphorus flame retardants are also available commercially for example from Struktol under the trade name Polyphlox™ 3710; from ICL-IP under trade names Fyrol™ HF, FyrolFlex™ SOL-DP™ or RDP; and Teijin under the trade name FCX-210.

In one or more embodiments, a combustion suppression system may include 1 to 100% by weight phosphorus flame retardant based on the total weight of said combustion suppression system. In one or more embodiments, the phosphorus flame retardant is present in the first cellulose ester-based composition in an amount of from 1 to 30% by weight or from 2% to 25% by weight based on the total weight of the plasticized cellulose ester-based composition.

In one or more embodiments, particularly but not exclusively in embodiments wherein the first plasticized cellulose ester-based composition includes phosphorus flame retardant, preferably as substantially 100% by weight of a combustion suppression system, the first cellulose ester-based composition may further include from 1% to 60% by weight or from 25% to 60% by weight or at least 30% by weight or at least 35% by weight or at least 40% by weight or at least 50% by weight based on the total weight of the composition of a non-combustion-suppression filler. Non-combustion-suppression fillers are intended to include materials that are traditionally used as fillers in polymeric compositions as well as materials which may act or perform as fillers while being added for functional purposes other than combustion suppression. Non-limiting examples of non-combustion-suppression fillers include calcium carbonate, talc, silica, clay, titanium dioxide, barium sulfate, graphite, expandable graphite, carbon black, boron nitride, calcium sulfate, wood flour, wood fiber and the like.

In one or more embodiments, the first plasticized cellulose ester-based composition includes mineral-based water-releasing agent and phosphorus flame retardant. In one or more embodiments, the combustion suppression system comprises from 1% to 99% by weight mineral-based water-releasing agent and from 99% to 1% by weight phosphorus flame retardant based on the total weight of said combustion suppression system, with the sum of the weight percent of mineral-based water-releasing agent and the weight percent phosphorus flame retardant equal to at least 90% or at least 95% or at least 96% or at least 97% or at least 98% or at least 99% or 100% of the total weight of the combustion suppression system.

The core layer includes or is formed from a first plasticized cellulose ester-based composition that includes cellulose ester and plasticizer. A cellulose ester is generally defined to include cellulose esters of one or more carboxylic acids and are described for example in U.S. Pat. No. 5,929,229, assigned to the assignee of the present invention, the contents and disclosure of which are incorporated herein by reference. Non limiting examples of cellulose esters include cellulose acetate, cellulose diacetate, cellulose propionate, cellulose butyrate, so-called mixed acid esters such as cellulose acetate propionate and cellulose acetate, and combinations thereof. In one or more embodiments, the at least one cellulose ester is selected from the group consisting of cellulose acetate, cellulose acetate propionate, cellulose acetate butyrate and combinations thereof. In one or more embodiments, the cellulose ester is cellulose acetate. In one or more embodiments, the at least one cellulose ester is cellulose acetate propionate. In one or more embodiments, the at least one cellulose ester is cellulose acetate butyrate. In one or more embodiments, the at least one cellulose ester is a combination of cellulose acetate propionate and cellulose acetate butyrate.

In one or more embodiments, the amount of cellulose ester in the first plasticized cellulose ester-based composition may be between 30% and 75% by weight, or between 30% and 50%, or between 35% and 45%, all based on the total weight of the first plasticized cellulose ester-based composition.

The cellulose ester of the present invention may be characterized using one or more characteristics. For example, in one or more embodiments, the cellulose ester may have a number average molecular weight (“Mn”) that is in the range of from 20,000 Da to 100,000 Da. In one or more embodiments, the cellulose ester has a Mn that is in the range of from about 20,000 Da to about 80,000 Da.

The cellulose ester may have in one or more embodiments a solution ball-drop viscosity of 2 to 30 or 4 to 25 or 5 to 20 seconds as measured by ASTM D817.

The cellulose ester may have in one or more embodiments a degree of substitution of the hydroxyl substituent (DSOH) of from 0.05 to 1.0, or a degree of degree of substitution of the acetyl (DSAC) of from 0.01 to 0.7. By way of brief background, DSOH and DSAC are measures of the degree of esterification for a given cellulose ester. Cellulose has three hydroxyls per anhydroglucose unit, located at the C2, C3 and C6 carbons, that can be esterified to varying degrees and in different ratios with various acyl groups, with the type of cellulose ester formed depending on the functionalization of the hydroxyl groups. For cellulose triacetate, for example, in which substantially all hydroxyl groups of the cellulose functionalized with acetyl groups, the degree of substitution of the acetyl (“DSAC”) is approximately 2.90, and the degree of substitution of the hydroxyl (“DSOH”) is approximately 0.10. Cellulose diacetate has a DSAC of approximately 2.5 and a DSOH of approximately 0.5.

The cellulose ester may in one or more embodiments have a glass transition temperature (Tg) of 50° C. to 200° C. or from 70° C. to 180° C. or no more than 160° C.

The cellulose ester may in one or more embodiments have a percent crystallinity of less than 20% or less than 15% or less than 10% or less than 5% or from 5% to 10% or from 5% to 15% or from 5% to 20% or from 10% to about 20%. Crystallinity is described herein using, and measured in the context of the present invention from, the second heat cycle in accordance with ASTM D3418 and assuming an enthalpy of melting of 14 cal/g for the cellulose esters. In this method, the amount of crystallinity is measured under a prescribed heating history, more particularly the “2^{nd} cycle” cooling and heating in a DSC per ASTM D3418. In this method, the sample is first heated in the DSC to above its melting temperature to erase any prior crystallinity (i.e. the “first heat cycle”). Next the sample is cooled at 20 degrees C. per minute to below Tg, and then reheated at the same rate to above the melting temperature again (the “2nd heat cycle”). During this cooling and 2nd heating, the material will recrystallize to a certain degree, and this amount of crystallization is measured in the scan as the enthalpy of melting at the melting temperature.

The first plasticized cellulose ester-based composition includes at least one plasticizer. The amount of plasticizer in the first plasticized cellulose ester-based composition may be from 1% to 40% by weight or from 5% to 30% by weight based on the total weight of said first plasticized cellulose ester-based composition. The plasticizer may be any plasticizer known in the art useful for plasticizing cellulose esters, including for example aromatic phosphate ester plasticizer, alkyl phosphate ester plasticizer, dialkylether diester plasticizer, tricarboxylic ester plasticizer, polymeric polyester plasticizer, polyglycol diester plasticizer, polyester resin plasticizer, aromatic diester plasticizer, aromatic triester plasticizer, aliphatic diester plasticizer, carbonate plasticizer, epoxidized ester plasticizer, epoxidized oil plasticizer, benzoate plasticizer, polyol benzoate plasticizer adipate plasticizer, a phthalate plasticizer, a glycolic acid ester plasticizer, a citric acid ester plasticizer, a hydroxyl-functional plasticizer, a solid, non-crystalline resin plasticizer or combinations thereof. In one or more embodiments, the plasticizer has a molecular weight of at least 100 or from 100 to 800. In one or more embodiments, the plasticizer is chosen from triethylene glycol 2-ethyl hexanoate, acetyl triethyl citrate and combinations thereof.

In one or more embodiments, the first plasticized cellulose ester-based composition includes at least 1% by weight based on total plasticizer content weight of one or more non-phosphorus plasticizers selected from the group consisting of triethylene glycol 2-ethyl hexanoate (TEG2EH), bis 2-ethylhexyl adipate (DOA), glyceryl triacetate (Triacetin), glyceryl tripropionate (Tripropionin) and bis 2-ethylhexyl azelate (DOZ). It will be appreciated that at least some of the phosphorus flame retardants described herein may also provide a plasticizing functionality and therefore may be included in calculating the total plasticizer content of the compositions.

In one or embodiments, the first plasticized cellulose ester-based composition includes cellulose ester selected from a group consisting of cellulose acetate, cellulose acetate propionate, cellulose acetate butyrate and combinations thereof. In one or more embodiments, the first plasticized cellulose ester-based composition includes a phosphorus flame retardant selected from the group consisting of Resorcinol Diphenyl Phosphate (RDP), DOPO (6H-dibenz(C,E)(1,2)oxaphosphorin-6-oxide), resorcinol bis (2,6 xylyl phosphate) (RXP), triphenyl phosphate (TPP), tricresyl phosphate (TCP or TKP) triaryl phosphate (TAP), bisphenol A diphosphate (BAPP, BDP) and combinations thereof.

The first cellulose ester-based composition of the present invention may further include one or more of processing aids, impact modifiers and roll release agents. In one or more embodiments, the plasticized cellulose ester composition of the present invention may include at least one roll release agent. Suitable roll release agents are known in the art and are described for example in U.S. Pat. No. 6,551,688, the contents and disclosure of which are incorporated herein by reference. Examples of suitable roll release agents include without limitation lubricants, waxes such as amide waxes, fatty acids, fatty acid esters, fatty acid salts, saponified fatty acid salts and combinations thereof. Examples of a fatty acid esters include esters of montanic acid.

When included in the present invention, the at least one roll release agent is typically present in an amount of 0.1% to about 2.0% by weight based on the total weight of the composition. In one or more embodiments, the at least one roll release agent is present in an amount of 0.1% to 1.0% by weight based on the total weight of the composition. In one or more embodiments, the at least one roll release agent is present in an amount of 0.1% to 0.5% by weight based on the total weight of the composition. In one or more embodiments, the at least one roll release agent is present in amount of 0.5% to 1.0% by weight based on the total weight of the composition. In one or more embodiments, the at least one roll release agent is present in an amount of 1.0% to 2.0% by weight based on the total weight of the composition. In one or more embodiments, the at least one roll release agent is present in an amount of 1.5% to 2.0% by weight based on the total weight of the composition.

The present invention may further include at least one processing aid. Processing aids may for example improve the texture and “fusion” of the melt, improve melt strength, reduce composition melting time, reduce overall processing time and help with metal release from calendering rolls. Processing aids are known in the art and may be derived for example from acrylics, and acrylic copolymers although processing aids based on styrenics, carbonates, polyesters, other olefins, and siloxanes are known and commercially available. Suitable processing aids are commercially available and include without limitation Paraloid™ K-125 available from Dow; Kane-Ace® PA-20, PA-610, B622, MR01 and MP90 available from Kaneka Corporation; and Ecdel™ available from Eastman Chemical Company. In one or more embodiments, the at least one processing aid includes one or more of acrylic polymer, an acrylic copolymer, a styrenic polymer, a carbonate polymer, a polyester polymer, an olefin polymer and a siloxane polymer. In one or more embodiments, the at least one processing aid is selected from the group consisting of an acrylic polymer or an acrylic copolymer. In one embodiment, the processing aid comprises a Kane-Ace® acrylic processing aid.

The amount of the at least one processing aid present in the present invention may vary depending on, the type of processing aid and its molecular weight and viscosity, the other components of the composition and the composition's end-use application. In one or more embodiments, the at least one processing aid is present in an amount of 0% to about 3.0% by weight based on the total weight of the composition. In one or more embodiments, the at least one processing aid is present in an amount of 0.1% to 6.0% by weight based on the total weight of the composition. In one or more embodiments, the at least one processing aid is present in an amount of 0.5% to 6.0% by weight based on the total weight of the composition. In one or more embodiments, the processing aid is present in an amount of 0.5% to 3.0% by weight based on the total weight of the composition.

The present invention may also include at least one impact modifier. Examples of impact modifiers include core-shell polymers based on acrylics, including acrylic polymers, methacrylate butadiene styrene (MBS) polymers, silicone-acrylic polymers and combinations thereof. Other suitable impact modifiers include acrylonitrile-butadiene styrene (ABS), ethylene vinyl acetate copolymers, chlorinated polyethylenes, ethylene copolymers and combinations thereof. Impact modifier, if present, is typically present in an amount of 1% to about 20% by weight based on the total weight of the composition. In one embodiment of the composition.

The first plasticized cellulose ester-based composition of the present invention may further include one or more other ingredients or components such as for example lubricants, pigments, release aids, dispersing aids, antistatic agents, biocides, water repelling additives, rodenticides, dyes, colorants, and the like.

In one or more embodiments, the first plasticized cellulose ester-based composition has a melt viscosity according to ASTM 3835 of 1000 Poise to 5000 Poise or 2000 Poise to 5000 Poise at a temperature of 190° C. and a shear rate of 628 s⁻¹. Melt viscosities and shear rates in the subject ranges facilitate manufacture of films or sheets (useful as multilayer resilient flooring layers) formed via calendering as discussed in detail below and therefore are also relevant in regard to the second and third plasticized cellulose ester-based compositions described herein.

The top layer 40 of the multilayer resilient flooring article of the present invention includes or is formed from a second plasticized cellulose ester-based composition. This second plasticized cellulose ester-based composition includes cellulose ester and plasticizer. Suitable cellulose esters and plasticizers for the second plasticized cellulose ester-based composition are described herein in conjunction with the description of first plasticized cellulose ester-based composition and that description is intended to apply to, describe and support elements and features of the second cellulose ester-based composition and the top layer. Similarly, processing aids, impact modifiers, roll release agents and other ingredients that have been described elsewhere herein or in the context of the first cellulose ester-based composition may be included in the second plasticized cellulose ester-based composition in the amounts and ranges specified and that description is intended to apply to, describe and support elements and features of the second cellulose ester-based composition and the top layer except as otherwise indicated.

In one or more embodiments, the amount of cellulose ester in the second plasticized cellulose ester-based composition may be between 35% and 85% by weight, or between 45% and 85%, or between 50% and 80%, all based on the total weight of the second plasticized cellulose ester-based composition. In one or more embodiments, the amount of plasticizer in the second cellulose ester-based composition may be from 2% to 40% by weight or from 2% to 35% by weight based on the total weight of the second plasticized cellulose ester-based composition.

In one or embodiments, the second plasticized cellulose ester-based composition includes phosphorus flame retardant. In one or embodiments, the second plasticized cellulose ester-based composition includes cellulose ester selected from a group consisting of cellulose acetate, cellulose acetate propionate, cellulose acetate butyrate and combinations thereof. In one or more embodiments, the phosphorus flame retardant selected from the group consisting of Resorcinol Diphenyl Phosphate (RDP), DOPO (6H-dibenz(C,E)(1,2)oxaphosphorin-6-oxide), resorcinol bis (2,6 xylyl phosphate) (RXP), triphenyl phosphate (TPP), tricresyl phosphate (TCP or TKP) triaryl phosphate (TAP), bisphenol A diphosphate (BAPP, BDP) and combinations thereof.

In one or more embodiments, the multilayer resilient flooring article includes a core layer including a first plasticized cellulose ester-based composition including cellulose ester and plasticizer and a top layer including a second plasticized cellulose ester-based composition including cellulose ester and plasticizer; wherein said multilayer flooring article exhibits a corrected smoke density (non-flaming mode) of 450 or less when tested according to ASTM E-662. In one or more embodiments, the multilayer resilient flooring article of the present invention exhibits a “class 1” rating when tested according to ASTM E-648.

In one or more embodiments, Applicants have unexpectedly discovered that the multilayer resilient flooring of the present invention achieves both commercially acceptable smoke generation with a combustion suppression system in the core layer and without the presence of a combustion suppression system in the top layer. Accordingly, in one or more embodiments, the second plasticized cellulose ester-based composition or the top layer may be substantially free from a combustion suppression system. “Substantially free” is intended to mean less than 0.1% by weight based on the total weight of the second plasticized cellulose ester-based composition. Nonetheless, embodiments of the present invention wherein the second plasticized cellulose ester-based composition or the top layer includes phosphorus flame retardant, in particular a combustion suppression system with substantially 100% phosphorus flame retardant, are contemplated.

Suitable combustion systems, components therefor and amounts thereof, are described herein with respect to the first plasticized cellulose ester-based composition and that description is intended to apply to, describe and support elements and features of the second cellulose ester-based composition. Particularly suitable combustion suppression systems for the top layer or second plasticized cellulose ester-based composition consist essentially of or consist of a phosphorus flame retardant. In one or more embodiments, the combustion suppression system for the top layer or the second plasticized cellulose ester-based composition is substantially free of a mineral-based waster releasing agent.

In one or more embodiments, Applicants have also unexpectedly discovered that, in addition to achieving commercially acceptable flame resistance and/or smoke generation, the multilayer flooring articles of the present invention, and accordingly the plasticized cellulose ester-based compositions from which their layers are formed, achieve a surprising balance of composition processability and end-product resiliency and toughness as demonstrated for example by flexural modulus and impact strength measurements. Such advantages were particularly but not exclusively surprising in embodiments wherein at least one of the first and second plasticized cellulose ester-based compositions included at least 30% non-combustion suppression filler. Accordingly, in one or more embodiments, at least one of the first cellulose ester-based composition and the second cellulose ester-based composition of the present invention exhibits a flexural modulus as measured according to ASTM D790 of at least 300 MPa or at least 500 MPa or at least 1000 MPa or at least 1350 MPa. Further, in one or more embodiments, at least one of the first cellulose ester-based composition and the second cellulose ester-based composition of the present invention exhibits a flatwise impact strength when tested according to ASTM D3763 of at least 1.0 kJ/m² or at least 2.0 kJ/m² or at least 3.0 kJ/m². In one or more embodiments, at least one of the first cellulose ester-based composition and the second cellulose ester-based composition of the present invention exhibits a flexural modulus as measured according to ASTM D790 of at least 300 MPa or at least 500 MPa or at least 1000 MPa or at least 1350 MPa and a flatwise impact strength when tested according to ASTM D3763 of at least 1.0 kJ/m² or at least 2.0 kJ/m² or at least 3.0 kJ/m².

In embodiments wherein the multilayer resilient flooring of the present invention includes a print layer 30, the print layer 30 may include a third plasticized cellulose ester-based composition. This third plasticized cellulose ester-based composition includes cellulose ester and plasticizer. Suitable cellulose esters and plasticizers for the third plasticized cellulose ester-based composition are described herein in conjunction with the description of first and second plasticized cellulose ester-based compositions and those descriptions are intended to apply to, describe and support elements and features of the third plasticized cellulose ester-based composition. The amount of cellulose ester in the third plasticized cellulose ester-based composition may be between 30% and 90% by weight, or between 40% and 85% by weight, or between 45% and 85% by weight, all based on the total weight of the third plasticized cellulose ester-based composition. The amount of plasticizer in the third cellulose ester-based composition may be from 5% to 40% by weight or from 10% to 30% by weight based on the total weight of the third plasticized cellulose ester-based composition. Plasticizers, processing aids, impact modifiers, pigments, colorants, roll release agents, fillers and other ingredients as described in the context of the first and second plasticized cellulose ester-based compositions may also be included in the third plasticized cellulose ester-based composition in the amounts and ranges specified and that description is intended to apply to, describe and support elements and features of the third cellulose ester-based composition. Suitable combustion suppression systems for the print layer or third plasticized cellulose ester-based composition, components therefor and amounts thereof, are described herein with respect to the top layer and core layer and first and second plasticized cellulose ester-based compositions and that description is intended to apply to, describe and support elements and features of the third cellulose ester-based composition.

For avoidance of doubt, it is expressly noted that the individual formulations (meaning identity of components and their respective amounts) of the first, second and third plasticized cellulose ester-based compositions as described above may be selected separate and independent from each other based on for example the desired characteristics and performance attributes of their specific application. In some embodiments, for example, the formulation of first plasticized cellulose ester-based composition may be the same as the formulation of the second plasticized cellulose ester-based composition; however, in other embodiments, the formulation of the first plasticized cellulose ester-based composition may be different from the formulation of the second plasticized cellulose ester-based composition.

The first, second and third plasticized cellulose ester-based compositions are described above in the context of a multilayer resilient flooring article. In another aspect then, the present invention is directed to a plasticized cellulose ester-based composition useful in resilient flooring applications. In this aspect, the compositions of the present invention may include (i) cellulose ester; (ii) plasticizer; and (iii) a combustion suppression system of one or both of a mineral-based water releasing agent alumina trihydrate and a phosphorus flame retardant. Various details, features and embodiments regarding the compositions of the present invention are set forth elsewhere herein in the context of the first, second and third plasticized cellulose ester-based compositions for the multilayer flooring article of the present invention and that description is intended to apply to, describe and support elements and features of the compositions of the present invention. The compositions of the present invention may be useful in forming for example a core layer or a top layer or a print layer of a multilayer resilient flooring article.

In one or more embodiments, the compositions of the present invention are suitable for or capable of forming a calendered article such as for example a calendered sheet or film. Such a calendered sheet for film may be useful as a core layer, a top layer or a print layer of a multilayer resilient flooring article. “calendered article” is used to describe articles such as films or sheets formed using a calendering method with a molten polymer wherein the molten polymer is forced through the nips of counterrotating rolls to form a film or sheet, gradually squeezed down to a film or sheet of final thickness by optionally passing through additional rolls having a similar counterrotating arrangement (with the roll arrangements typically referred to as a “stack”); subjecting the film or sheet to additional treatment, such as for example stretching, annealing, slitting or the like and then winding the formed article on a winder. Calendering and calendered articles as those terms are used herein are described in more detail in U.S. Published Patent Application No. US2019/256674, assigned to the assignee of the present invention, the contents and disclosure of which are incorporated herein by reference. Such sheets of films may be useful as a top layer, a print layer or a core layer of a multilayer resilient flooring article.

In one or more of these embodiments, the plasticized cellulose ester-based composition has a melt viscosity according to ASTM 3835 of 1000 Poise to 5000 Poise or 2000 Poise to 5000 Poise at a temperature of 190° C. and a shear rate of 628 s⁻¹. In one or more embodiments, the first or second of third plasticized cellulose ester-based composition is capable of being calendered at the temperature range of the sum of the glass transition temperature of the cellulose ester of the composition minus 20° C. to the sum of the glass transition temperature of the cellulose ester of the composition plus 50° C.

Though the preceding description herein describes a utility of the compositions of the present invention in the field of calendering and calendered articles, one of ordinary skill in the art will appreciate that the composition of the present invention may also be useful in forming articles, including but not limited to films or sheets, by other known methods such as for example extrusion, injection molding, blow-molding, additive manufacturing (3D printing), profile extrusion, blown film, multilayer film, sheet laminate processes and the like.

The following examples, while provided to illustrate with specificity and detail the many aspects and advantages of the present invention, are not be interpreted as in any way limiting its scope. Variations, modifications and adaptations which do depart from the spirit of the present invention will be readily appreciated by one of ordinary skill in the art.

### Composition and Sample Preparation

Twenty (20) compositions/formulations were prepared to be formed into individual layers and then multilayer articles for testing as listed in Table 1 below, with a composition without a combustion suppression system numbered 1 and the remainder being plasticized cellulose ester-based compositions of the present invention. Details for composition components are as follows: CAP 482-20 is a high viscosity cellulose acetate propionate available from Eastman Chemical Company with a solution ball-drop viscosity of 20 seconds as measured by ASTM D817; RDP (Resorcinol Diphenyl Phosphate) is a liquid Phosphorus flame retardant available from ICL-IP and sold as Fyroflex™ RDP; Omyacarb™ UFT-FL is a calcium carbonate available from Omya; Micral™ 932 is alumina trihydrate available from Huber; triethylene glycol bis (2-EthylHexanoate) (TEGEH) a plasticizer is available from Eastman Chemical Company; Vikoflex™ 7170 is an epoxidized soybean oil available from Arkema. DOPO (6H-dibenz(C,E)(1,2)oxaphosphorin-6-oxide) is a reactive phosphorous flame retardant available from Struktol as Polyphlox™ 3710. Fyrol™ HF 10 is a liquid phosphorus flame retardant available from ICL-IP. FyrolFlex™ SOL-DP is a solid phosphorus flame retardant available from ICL-IP. FCX-210 is a solid phosphorus flame retardant available from Teijin.

TABLE 1

| Formulation | Material Description |
|---|---|
| 1 | CAP 482-20 + 22% TEGEH + 2% Vikoflex 7170 |
| 2 | CAP 482-20 + 22% RDP + 2% Vikoflex 7170 |
| 3 | CAP 482-20 + 11.4% TEGEH + 10.64% RDP + 2% Vikoflex 7170 |
| 4 | CAP 482-20 + 13.3 RDP + 38.9% Omyacarb UFT-FL + 2% Vikoflex 7170 |
| 5 | CAP 482-20 + 10.8% TEGEH + 29.7% Omyacarb UFT-FL + 20.4% Micral 932 + 1.9% |
| | Vikoflex 7170 |
| 6 | CAP 482-20 + 10.8% RDP + 29.7% Omyacarb UFT-FL + 20.4% Micral 932 + 1.9% |
| | Vikoflex 7170 |
| 7 | CAP 482-20 + 13.3% TEGEH + 38.9% Omyacarb UFT-FL + 1.9% Vikoflex 7170 |
| 8 | CAP 482-20 + 10.8% RDP + 50.4% Omyacarb UFT-FL + 1.5% Vikoflex 7170 |
| 9 | CAP 482-20 + 8.2% RDP + 2.6% TEGEH + 50.4% Omyacarb UFT-FL + 1.5% Vikoflex 7170 |
| 10 | CAP 482-20 + 5.2% RDP + 5.6% TEGEH + 50.4% Omyacarb UFT-FL + 1.5% Vikoflex 7170 |
| 11 | CAP 482-20 + 2.7% RDP + 8.1% TEGEH + 50.4% Omyacarb UFT-FL + 1.5% Vikoflex 7170 |
| 12 | CAP 482-20 + 5.6% RDP + 3.2% TEGEH + 60% Omyacarb UFT-FL + 1.2% Vikoflex 7170 |
| 13 | CAP 482-20 + 2.7% RDP + 6.0% TEGEH + 60% Omyacarb UFT-FL + 1.2% Vikoflex 7170 |
| 14 | CAP 482-20 + 4.1% RDP + 4.6% TEGEH + 60% Omyacarb UFT-FL + 1.2% Vikoflex 7170 |
| 15 | CAP 482-20 + 8.4% RDP + 2.4% TEGEH + 29.85% Omyacarb UFT-FL + 20.5% Micral |
| | 932 + 1.5% Vikoflex 7170 |
| 16 | CAP 482-20 + 5.6% RDP + 5.2% TEGEH + 29.85% Omyacarb UFT-FL + 20.5% Micral |
| | 932 + 1.5% Vikoflex 7170 |
| 17 | CAP 482-20 + 2.7% RDP + 8.1% TEGEH + 29.85% Omyacarb UFT-FL + 20.5% Micral |
| | 932 + 1.5% Vikoflex 7170 |
| 18 | CAP 482-20 + 2.7% RDP + 8.1% TEGEH + 14.9% Omyacarb UFT-FL + 35.45% Micral |
| | 932 + 1.5% Vikoflex 7170 |
| 19 | CAP 482-20 + 2.7% RDP + 8.1% TEGEH + 0% Omyacarb UFT-FL + 50.4% Micral 932 + |
| | 1.5% Vikoflex 7170 |
| 20 | CAP 482-20 + 0% RDP + 10.8% TEGEH + 0% Omyacarb UFT-FL + 50.4% Micral 932 + |
| | 1.5% Vikoflex 7170 |

For all items, compositions were formulated then compounded on a Leistritz 18 mm twin screw compounding extruder. Extruder zone (Z1 through Z9) temperatures were set at for Z1 70° C., Z2, 140° C., Z3 170° C., Z4 180° C., Z5 185° C., Z6 190° C., and Z7, Z8, Z9 200° C. The die temperatures were set at 200° C. The extruder was run at 500 rpm. A single strand approximately 1 mm in diameter was extruded into a batch with water to cool the melted material and conveyed to a pelletizer. The pellets were then either extruded or injection molded depending on if they samples were going to be tested for Flame Spread (ASTM E-648) or Smoke Development (ASTM E-662).

Formulations were then extruded into film to be utilized as layers of resilient multilayer samples for testing. Compounded pellets were dried for 8 hours at 60° C. and films of ˜12″ wide of 0.020″ thickness (to simulate a top layer) and 0.040″ thickness (to simulate a core layer) were extruded using a 1.5″ Killion extruder. Extruder zone (Z1 through Z4) temperatures were set at for Z1 365° F., Z2 375° F., Z3 375° F.; clamp and adaptor temperature at 375° F.; and die zones 1, 2, and 3 at 380° F. For smoke density testing, items numbered 1 to 7 in Table 2 below, multilayer resilient articles were formed by laminating two individual core layers and one top layer samples for a total multilayer sample thickness of 0.100 inches. Two core layers were used to meet testing equipment requirements for sample thickness. 3″ by 3″ multilayer samples for smoke density testing (ASTM E662) were formed by precutting the individual layers to desired dimensions and then laminating the test specimens (two core layers, one top layer) using a Carver press at a temperature of 140° C. and a pressure of 5000 psi for a time of 12 minutes. Selected samples were also formed for evaluating flame spread characteristics under ASTM E-648. As testing specimens for ASTM E-648 are to have dimensions of 8″×40″ and the Carver press platen size is 14″×14″, the multilayer samples for flame testing had to be sequentially laminated by pressing one section, moving the laminate, pressing the next section, then moving the sample and pressing the final section. Carver press was set at a temperature of 140° C. and a pressure 9000 psi for a time of 12 minutes between the two metal platens.

Additional samples were also assembled for further smoke density (ASTM E662) testing as numbered 8 through 20 in Table 2 below. For these additional samples, formulation pellets were dried at 60° C. for 4 hours and plaques of 0.080 inches thickness (to simulate a core layer) were injection molded on a Toyo Ti-90C injection molding press. Heater zones were set at 460° F. Cooling water was set at 160° F. Injection time was 25%. Pressure was 800 psi. Cooling time was 12 seconds. Multilayer resilient articles were then formed by laminating individual injection molded core layers and top layer (0.020 inch thickness) as described above by pressing in a Carver press at 140° C. on the top layer side and 130° C. on the core layer side at 6000 psi for 12 minutes between two Teflon™ plates with Kapton™ release films. Samples (size 4″×4″) were subsequently machined to 3″×3″ as specified in ASTM E662.

Selected core layer formulations from Table 1 were also injection molded into flex bars as specified according to ASTM D790 and ASTM D3763 for flexural modulus and flatwise impact strength testing, respectively, with the results are shown in conjunction with the related laminate constructions in Table 2 below.

Smoke suppression was assessed by measuring corrected non-flaming smoke density according to ASTM E 662. A corrected non-flaming smoke density of 450 or less reflects commercially acceptable smoke generation per NFPA Life Safety Code 101. Flame spread resistance was also assessed for certain samples by measuring critical radiant flux according to ASTM E 648. A flame spread resistance rating of “class 1”, which deemed commercially acceptable by International Building Code published by the International Code Council, requires a critical radiant flux of less than 0.45 w/m².

TABLE 2

| | | | | Smoke | | |
|---|---|---|---|---|---|---|
| | | | | Density | Physical Properties | |
| | | | Flame | (ASTM | Flatwise | |
| Laminate Constructions | | | Spread | E662) Data | Impact | Flexural |
| | Top Layer Film | Core | (ASTM | Corrected | Strength | Modulus |
| Laminate | Formulation | Formulation | E648) Data | Smoke | (ASTM | (ASTM |
| Construction | (20 mil | (80 mil | Class | Density - Non | D3763) | D790) |
| Number | thickness) | thickness) | Rating | Flaming Mode | (kJ/m2) | (MPa) |
| 1 | 1 | 6 | 1 | 333 | no data | no data |
| 2 | 2 | 4 | 1 | 274.3 | no data | no data |
| 3 | 2 | 5 | 1 | 500 | no data | no data |
| 4 | 2 | 6 | 1 | 218.3 | no data | no data |
| 5 | 3 | 5 | 1 | 496 | no data | no data |
| 6 | 3 | 6 | 1 | 321.3 | no data | no data |
| 7 | 1 | 8 | no data | 423.3 | 4.8 | 2201 |
| 8 | 1 | 9 | no data | 441.7 | 4.3 | 2185 |
| 9 | 1 | 10 | no data | 536.3 | 4.9 | 1649 |
| 10 | 1 | 11 | no data | 565.3 | 7.4 | 1350 |
| 11 | 1 | 12 | no data | 504.7 | 4.0 | 2128 |
| 12 | 1 | 13 | no data | 561.7 | no data | no data |
| 13 | 1 | 15 | no data | 414.0 | 5.6 | 2326 |
| 14 | 1 | 16 | no data | 332.3 | 6.2 | 1906 |
| 15 | 1 | 17 | no data | 369.0 | 8.2 | 1681 |
| 16 | 1 | 18 | no data | 436.0 | 7.7 | 1817 |
| 17 | 1 | 19 | no data | 392.0 | 6.6 | 2049 |
| 18 | 1 | 20 | no data | 430.7 | 12.4 | 1829 |

Of particular note from the data in Table 2 are the following points:
1. Sample laminate 1 from Table 2, which includes a core layer formed from a plasticized cellulose ester-based composition that included phosphorus flame retardant and ATH and a top layer free of a combustion suppression system, surprisingly achieved an acceptable corrected non-flaming smoke density of 333 under ASTM E662 (along with a “class 1” rating under ASTM E648).
2. Sample laminates 2 and 8 from Table 2, in which the core layer was formed from a plasticized cellulose ester-based composition that included phosphorus flame retardant (RDP) as 100% of the combustion suppression system (i.e. it was free of a mineral based water releasing agent) and over 30% by weight calcium carbonate, surprisingly achieved an acceptable smoke acceptable corrected non-flaming smoke density of 274 and 423 respectively under ASTM E662 (along with a “class 1” rating under ASTM E648). 3. Sample laminates 1, 4 and 7 from Table 2 in which the core layer was formed from a plasticized cellulose ester-based composition that included ATH and phosphorus flame retardant (RDP), surprisingly achieved acceptable corrected non-flaming smoke generation under ASTM E662 (along with a “class 1” rating under ASTM E648).

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A multilayer resilient flooring article, said article comprising a core layer comprising a first plasticized cellulose ester-based composition comprising cellulose ester and plasticizer and a top layer comprising a second plasticized cellulose ester-based composition comprising cellulose ester and plasticizer; wherein said first plasticized cellulose ester-based composition further comprises a mineral-based water releasing agent.

2. The multilayer resilient flooring article of claim 1 wherein said first plasticized cellulose ester-based composition further comprises mineral-based water releasing agent and phosphorus flame retardant.

3. The multilayer resilient flooring article of claim 1 wherein said mineral-based water releasing agent is selected from the group consisting of alumina trihydrate and magnesium hydroxide.

4. The multilayer resilient flooring article of claim 3 wherein said mineral-based water releasing agent is alumina trihydrate.

5. The multilayer resilient flooring article of claim 3 wherein said mineral-based water releasing agent is present in the amount of from 20% to 60% by weight based on the total weight of said composition.

6. The multilayer resilient flooring article of claim 1 wherein said second plasticized cellulose ester-based composition further comprises phosphorus flame retardant.

7. A multilayer resilient flooring article, said article comprising a core layer comprising a first plasticized cellulose ester-based composition comprising cellulose ester and plasticizer and a top layer comprising a second plasticized cellulose ester-based composition comprising cellulose ester and plasticizer, wherein said first plasticized cellulose ester-based composition further comprises a phosphorus flame retardant.

8. The multilayer resilient flooring article of claim 7 wherein said phosphorus flame retardant is present in the amount of from 1% to 30% by weight based on the total weight of said composition.

9. The multilayer resilient flooring article of claim 7 wherein said first cellulose ester-based composition further comprises a mineral-based water releasing agent.

10. The multilayer resilient flooring article of claim 7 wherein said cellulose ester of said first cellulose ester-based composition is group consisting of cellulose acetate, cellulose acetate propionate, cellulose acetate butyrate and combinations thereof.

11. The multilayer resilient flooring article of claim 7 wherein said first plasticized cellulose ester-based composition further comprises from 25% to 60% by weight filler selected from the group consisting of calcium carbonate, talc, silica, clay, titanium dioxide, barium sulfate, graphite, expandable graphite, carbon black, boron nitride and calcium sulfate.

12. The multilayered flooring article of claim 1 further comprising a print layer between said top layer and said core layer.

13. A multilayer resilient flooring article, said article comprising a core layer comprising a first plasticized cellulose ester-based composition comprising cellulose ester and plasticizer and a top layer comprising a second plasticized cellulose ester-based composition comprising cellulose ester and plasticizer, wherein said multilayer flooring article exhibits a corrected non-flaming smoke density of 450 or less when tested according to ASTM E-662.

14. The multilayer resilient flooring article of claim 13 wherein said multilayer flooring article exhibits a “class 1” rating when tested according to ASTM E-648.

15. The multilayer resilient flooring article of claim 1 wherein at least one of said first plasticized cellulose ester-based composition and said second plasticized cellulose ester-based composition comprises composition further includes at least 1% based on total plasticizer content weight in said composition of one or more non-phosphorus plasticizers selected from the group consisting of triethylene glycol 2-ethyl hexanoate, bis 2-ethylhexyl adipate, glycerin triacetate, glyceryl tripropionate and bis 2-ethylhexyl azelate.

16. The resilient multilayer flooring article of claim 7 wherein the first plasticized cellulose ester-based composition includes cellulose ester is selected from a group consisting of cellulose acetate, cellulose acetate propionate, cellulose acetate butyrate and combinations thereof and said phosphorus flame retardant is selected from the group consisting of Resorcinol Diphenyl Phosphate (RDP), DOPO (6H-dibenz(C,E)(1,2)oxaphosphorin-6-oxide), resorcinol bis (2,6 xylyl phosphate) (RXP), triphenyl phosphate (TPP), tricresyl phosphate (TCP or TKP) triaryl phosphate (TAP), bisphenol A diphosphate (BAPP, BDP) and combinations thereof.

17. The resilient multilayer flooring article of claim 13 wherein at least one of said first plasticized cellulose ester-based composition and said second plasticized cellulose ester-based composition exhibits a flexural modulus as measured according to ASTM D790 of at least 300 MPa.

18. The resilient multilayer flooring article of claim 13 wherein at least one of said first plasticized cellulose ester-based composition and said second plasticized cellulose ester-based composition exhibits a flatwise impact strength when tested according to ASTM D3763 of at least 1.0 kJ/m².

19. The resilient multilayer flooring article of claim 13 wherein at least one of said first plasticized cellulose ester-based composition and said second plasticized cellulose ester-based composition exhibits a flexural modulus as measured according to ASTM D790 of at least 300 MPa and a flatwise impact strength when tested according to ASTM D3763 of at least 1.0 kJ/m².
